(19) United States
(12) Patent Application Publication
(10) Pub. No.: US 2016/0176432 A1
(43) Pub. Date: Jun. 23, 2016

(54) Gliding motion apparatus in use with an infant/toddler carrier

(71) Applicant: Jami Josephine Lewis, Stockton, CA (US)

(72) Inventor: Jami Josephine Lewis, Stockton, CA (US)

(21) Appl. No.: 14/577,586

(22) Filed: Dec. 19, 2014

(51) Int. Cl. B62B 9/22; H01R 24/58; B62B 7/00; B62B 9/00; B62B 9/20

(52) U.S. Cl. CPC B62B 9/22; B62B 9/005; B62B 9/20; B62B 7/006; H01R 24/58

(57) ABSTRACT

A gliding motion apparatus is for use in combination with a standard infant/toddler carrier such as a car seat or bassinet. The motion apparatus is comprised of a support structure, an inner frame within the stroller frame for receiving the transportable base of an infant car seat or bassinet. The inner frame comprises of a glider mech mechanism and bearing assembly that allow for a horizontal back and fourth gliding motion. Gliding motion apparatus also consists of stroller frame having audio sound speakers within frame structure, a 3.5 mm male audio jack within frame structure, and reflective lighting rims.

### FIELD OF INVENTION

The invention relates to a stroller, and more particularly to a stroller having a gliding motion seat in conjunction with the use of an infant car seat or bassinet.

### BACKGROUND OF THE INVENTION

Infants and young children have needed to be carried for as long as parents have needed to go places, and different cultures have devised ingenious methods to ease the burden of bearing the weight of a small child on long, or even short walks.

As every parent comes to find out, a stroller is a necessity when it comes to having a baby. Parents often appreciate any help they can be given to help them cope with the many times overwhelming task of taking care of their little ones. The proper stroller can make parents daily activities with a baby or small child much easier and less tiring. Fortunately, with the many advancements made for improving baby gear technology, transporting your child has become a far more comfortable and enjoyable activity than ever before.

Today, many varieties of baby carriages, or strollers, are available, from models that allow the child to lie down to those that keep the child upright. The invention has become more versatile as well, with collapsible versions, models that convert into car seats, jogging strollers, and travel systems just to name a few.

One thing that is a given is that babies cry a lot. Sometimes the reason is obvious: baby is hungry, wet, or tired, and wants you to address his/her needs. Other times getting a baby to stop crying is not a simple process. That's why figuring out how to soothe and calm a baby when nothing else seems to do the trick is so important.

The advantage of the stroller is that it has a smooth, consistent motion of a stroller ride, in addition the snug comfort of the car seat or carrier of the stroller greatly contributes to helping fussy babies fall asleep.

### BRIEF DESCRIPTION OF THE DRAWINGS

FIG. 1A is a side view of the embodiment of the stroller in accordance with one or more aspects the present invention;

FIG. 1B is a perspective view of the present invention.

FIG. 1C is a bottom view of the present invention.

FIG. 1D is a rear view of the present invention.

FIG. 2A is a side view of the embodiment in an alternate position depicted in FIGS. 1A and 1B, shown with the seat in a forward glide motion.

FIG. 2B is a side view of the embodiment in an alternate position depicted in FIGS. 1A and 1B, shown with the seat in a backward glide motion.

### DETAILED DESCRIPTION OF THE DRAWINGS

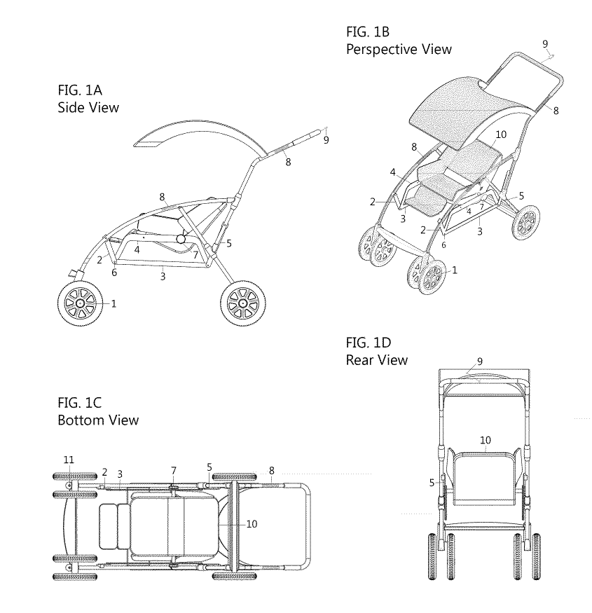

FIG. 1A shows a side view in an assembled state. Number 1 shows reflective lighting on the rim of the tire. Number 2, 3, and 5 are the flat leg rods as part of the support structure. Number 4 is the upper frame that is attached to numbers 2, 3, and 5 as part of the support structure. Number 6 is the bearing assembly that connects numbers 2, 3, 4, and 5 causing a swivel action that allows the back and fourth gliding movement. Numbers 2, 3, 4, 5, and 6 as a whole structure is the said gliding device angle-limiting mechanism. Number 7 is the locking mechanism, which locks the detachable infant carrier and/or bassinet in place. Number 8 shows the dual audio sound speakers that are mounted within the stroller frame. Number 9 shows the 3.5 mm male audio jack connected from the speakers to the top of the push handle assembly. The 3.5 mm male audio jack is used for connecting audio and mobile devices.

FIG. 1B shows a perspective view in an assembled state. The detailed description is the same as in FIG. 1A with the addition of number 10. Number 10 is a detachable infant seat that detaches from number 7.

FIG. 1C shows a bottom view in an assembled state. Number 11 depicts a hollow tube that has an inner catch mechanism to allow a bar to be placed up and held in the tube until it is released. This feature is used for a customized stroller attachment. Numbers 2, 3, and 5 are the flat leg rods. Number 7 is the locking mechanism. Number 8 is the audio sound speakers. Number 10 is the infant seat.

FIG. 1D shows a rear view in an assembled state. Number 5 is the rear flat leg rod. Number 9 is the 3.5 mm audio male jack. Number 10 is the infant seat.

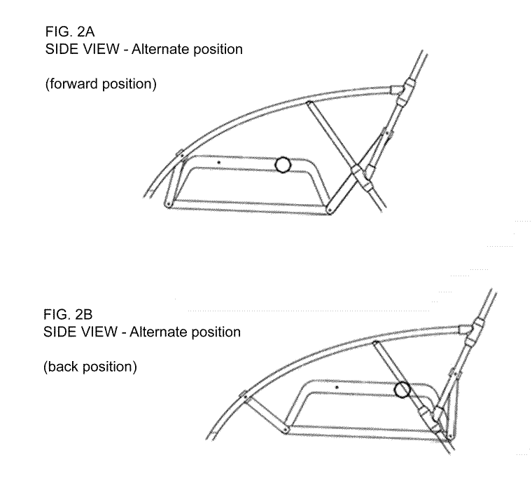

FIG. 2A shows an alternate position of the embodiment in side view. The embodiment is in a leaned forward position.

FIG. 2B shows an alternate position of the embodiment in side view. The embodiment is in the leaned back position.

1. A gliding motion apparatus for use with an infant/toddler car carrier or bassinet, the apparatus comprising: a support structure; a frame having two opposite sides, each which includes a front leg flat rod, a rear leg flat rod, a flat rod extending between the front and rear leg rod; and an upper frame with a locking mechanism; said gliding device including having an angle-limiting mechanism on two opposite sides connecting to the stroller frame; reflective lighting wheel rims; dual audio sound speakers mounted within the push handle assembly; dual audio sound speakers mounted within the stroller frame; a 3.5 mm male audio jack used for connecting audio and mobile devices.

2. The apparatus of claim 1, wherein said frame is attached to said support structure by bearing assembly, and wherein said angle-limiting mechanism causes an horizontal gliding motion in said frame.

3. The apparatus of claim 1, wherein said angle-limiting mechanism comprises a bearing assembly.

4. The apparatus of claim 3, wherein said bearing assembly consists of bearing, washers, and nut.

5. The apparatus of claims 1, 2, 3, and 4, wherein said frame attaches stationary to bracket A with bolt, at upper end of bracket A; bottom of bracket A attaches to bottom of bracket B with bearing which allows for free swing motion between the two brackets; and top of bracket B attaches to support structure with bearing allowing for free swing motion between bracket and support structure.

6. The apparatus of claim 1, wherein said upper frame comprises a locking mechanism.

7. The apparatus of claim 1, wherein said comprising of reflective lighting wheel rims surrounded by a rubber treaded tire.

8. The apparatus of claim 1, wherein said dual audio sound speakers are mounted within each side of the push handle assembly frame.

9. The apparatus of claim 1, wherein said dual audio sound speakers are mounted within each side of the stroller frame.

10. The apparatus of claim 1, wherein said a 3.5 mm male audio jack within frame used for connecting audio and mobile devices.

11. The apparatus of claim 8 and 10, wherein said the 3.5 mm male audio jack connects to a split set of wires leading to the each side of the handle assembly which connects to the audio speakers mounted within the push handle assembly frame.

12. The apparatus of claim 9 and 10, wherein said the 3.5 mm male audio jack connects to a split set of wires leading to the each side of the stroller frame which connects to the audio speakers mounted within the stroller frame.

13. The apparatus of claims 10 and 11, wherein said the 3.5 mm male audio jack is located at the top frame of the push handle assembly.
